(19) United States
(12) Patent Application Publication
(10) Pub. No.: US 2025/0039720 A1
(43) Pub. Date: Jan. 30, 2025

(54) PAGING FOR LOW-POWER WAKE UP FOR A USER EQUIPMENT

(71) Applicant: Lenovo (Singapore) Pte. Limited, Singapore (SG)

(72) Inventors: Shwetha Sreejith, Steinbach (DE); Prateek Basu Mallick, Dreieich (DE); Joachim Löhr, Wiesbaden (DE); Karthikeyan Ganesan, Kronberg Im Taunus (DE)

(73) Assignee: Lenovo (Singapore) Pte. Limited, Singapore (SG)

(21) Appl. No.: 18/781,726

(22) Filed: Jul. 23, 2024

Related U.S. Application Data
(60) Provisional application No. 63/515,226, filed on Jul. 24, 2023.

(51) Int. Cl. H04W 24/10; H04W 52/02; H04W 68/02

(52) U.S. Cl. CPC H04W 24/10; H04W 52/0235; H04W 68/02

(57) ABSTRACT

Various aspects of the present disclosure relate to paging for low-power wake up for a user equipment. An apparatus, such as a UE, receives a first configuration for calculating one or more low-power radio monitoring occasions and a second configuration for calculating one or more main radio monitoring occasions. The UE can control a low-power radio and a main radio based at least in part on the first configuration and the second configuration.

### RELATED APPLICATION

This application claims priority to U.S. Provisional Application Ser. No. 63/515,226 filed 24 Jul. 2024 entitled “PAGING FOR LOW-POWER WAKE UP FOR A USER EQUIPMENT,” the disclosure of which is incorporated by reference herein in its entirety.

### TECHNICAL FIELD

The present disclosure relates to wireless communications, and more specifically to radio management in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system the UE may be a low-power UE and may have one or more reduced capabilities relative to another UE (e.g., a high-power UE). For example, the UE may be a low-power UE due to reduced processing capabilities, reduced battery capacity, reduced communication capabilities, or the like. The UE may use multiple radios to monitor for paging messages in the RRC idle mode. For example, the UE may use a main radio when relatively geographically far from a NE and a low-power wake-up radio when relatively geographically close to a NE, where the low-power wake-up radio may use relatively less power than the main radio for exchanging signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include transmitting, to a UE, a first configuration for calculating one or more low-power radio monitoring occasions and a second configuration for calculating one or more main radio monitoring occasions; transmitting, to the UE, one or more low-power radio paging indications on the one or more low-power radio monitoring occasions; and transmitting, to the UE, one or more main radio paging indications on the one or more main radio monitoring occasions.

Some implementations of the method and apparatuses described herein may further include where the first configuration includes an indication that the one or more low-power radio monitoring occasions are to be at least a time slot threshold earlier than the one or more main radio monitoring occasions; the time slot threshold is configured to enable a low-power radio to wake up a main radio before the main radio is configured to start receiving and transmitting; one or more of the first configuration or the second configuration includes an indication that if the UE is paged on a low-power monitoring occasion, a low-power radio is to wake a main radio; one or more of the first configuration or the second configuration includes an indication that if the UE is not paged on a low-power monitoring occasion, a low-power radio is to wake a main radio; one or more of the first configuration or the second configuration includes an indication that if the UE is paged on a low-power monitoring occasion and paging is not directed to the UE, a low-power radio is not to wake a main radio.

Some implementations of the method and apparatuses described herein may further include determining that the UE moves to a different base station; and transmitting one or more of the first configuration or the second configuration to the different base station; transmitting one or more of the first configuration or the second configuration to a network function; receiving one or more of the first configuration or the second configuration from one or more of a different base station or a network function; transmitting one or more of the first configuration or the second configuration via periodic system information broadcast; the one or more of the first configuration or the second configuration specifies a monitoring occasion pattern for the one or more low-power radio monitoring occasions relative to the one or more main radio monitoring occasions.

Some implementations of the method and apparatuses described herein may further include receiving a first configuration for calculating one or more low-power radio monitoring occasions and a second configuration for calculating one or more main radio monitoring occasions; and controlling a low-power radio and a main radio based at least in part on the first configuration and the second configuration.

Some implementations of the method and apparatuses described herein may further include controlling the low-power radio and the main radio includes: determining, based at least in part on the first configuration, whether the UE is paged on a low-power radio monitoring occasion; and controlling the main radio based at least in part on whether the UE is paged on the low-power radio monitoring occasion; controlling the low-power radio and the main radio includes: determining that paging is received on the low-power radio monitoring occasion and that the UE is paged; and waking the main radio; notifying the main radio that the UE is paged on the low-power radio monitoring occasion; controlling the low-power radio and the main radio includes: determining that paging is not received on the low-power radio monitoring occasion; and waking the main radio on a main radio monitoring occasion; notifying the main radio that the UE failed to receive paging on the low-power radio monitoring occasion; controlling the low-power radio and the main radio includes: determining that paging is received on the low-power radio monitoring occasion and that the UE is paged; determining that the paging is not directed to the UE; and maintaining the main radio in a sleep mode; controlling the low-power radio and the main radio includes: waking the main radio based at least in part on whether the UE is paged on a low-power radio monitoring occasion; and notifying the main radio of a reason for waking the main radio; receiving one or more of the first configuration or the second configuration via system information broadcast from a base station.

### BRIEF DESCRIPTION OF THE DRAWINGS

FIG. 1 illustrates an example of a wireless communications system in accordance with aspects of the present disclosure.

FIG. 2 illustrates an example initial access process for a UE in 5G.

FIG. 3 illustrates at example monitoring occasions for a low-power radio and a main radio in accordance with aspects of the present disclosure.

FIG. 4 illustrates a scenario for an example procedure for paging context in a radio network (e.g., for different gNB of a radio network) in accordance with aspects of the present disclosure.

FIG. 5 illustrates a scenario for transmitting paging context in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method in accordance with aspects of the present disclosure.

FIG. 10 illustrates a flowchart of a method in accordance with aspects of the present disclosure.

### DETAILED DESCRIPTION

In wireless communications systems a radio network may page a UE differently depending on which radio is currently active at the UE side. If a UE goes out of low-power radio coverage without informing the gNB and a main radio is asleep, the UE may lose connectivity with the network and may no longer be reachable. Hence, there some form of information is to be shared between the gNB and the UE of where (e.g., on which radio) regarding where the UE can be paged. If only one UE radio (e.g., either low-power radio or main radio) is in active reception status, this may cause the UE to miss one or more paging messages if the gNB is unaware of the UE paging status, e.g., active radio in the UE, the active radio monitoring occasion, etc.

Accordingly, the present disclosure provides for ways for managing low-power wake up for a UE. For instance, implementations provide for enhancement on the monitoring occasions (e.g., paging occasions) of the low-power radio and main radio of a UE. The monitoring occasions of low-power radio and main radio, for instance, are configured by gNB such that power saving gain may be maximized. For example, by enabling different low-power radio and main radio monitoring occasions configurations, UE power consumption can be reduced. This can be achieved by allowing the main radio to remain in sleep mode as long as the low-power radio is in active paging reception status and the UE does not have data to transmit.

Further, implementations described in this disclosure enable a gNB of a cell where a UE previously transitioned to RRC_IDLE Mode to store the most recent low-power radio/main radio state of the UE, such as identified using UE Paging Identity, e.g. System Architecture Evolution Temporary Mobile Station Identifier (S-TMSI). This paging radio information can be shared with surrounding gNBs (e.g., over the Xₙ interface), such as when a paging radio change occurs.

Further, implementations described in this disclosure enable a low-power radio and/or main radio state of a UE to be indicated to the AMF by the gNB (e.g., the gNB of the cell where the UE currently exists) when the gNB receives a paging radio notification. The AMF can maintain this information as part of the paging context of the UE. When the UE is to be paged, the AMF can provide the paging radio information to the new gNB where the UE is now connected.

By utilizing the described techniques, power consumption can be decreased and UE connectivity reliability can be increased.

Aspects of the present disclosure are described in the context of a wireless communications system.

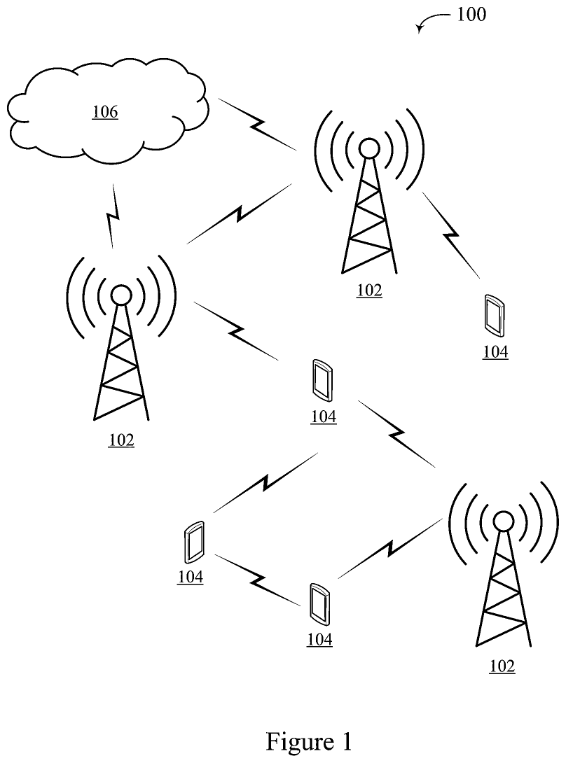

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) communicates to a UE 104 paging configuration for the UE 104 concerning paging of a low-power radio and/or a main radio of the UE 104. The UE 104 can configure operation of the low-power radio and the main radio based at least in part on the paging configuration. Further, the paging configuration can be shared among different NE 102, such as to accommodate scenarios where the UE 104 moves between different NE 102 and/or different cells.

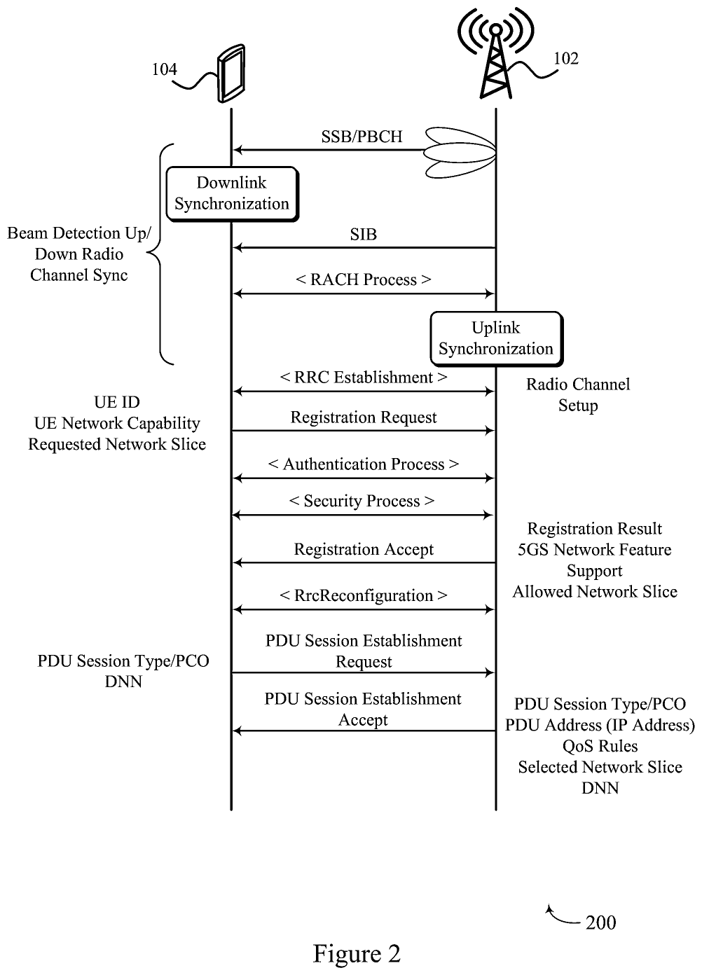

FIG. 2 illustrates an example initial access process 200 for a UE in 5G. For instance, in wireless communication scenarios when a UE is first powered on it can perform a cell search, cell selection, and cell reselection. The UE can be downlink synchronized after which the UE can perform a random access channel (RACH) procedure to be registered to the network such as initiated by a NAS PDU. As part of the RACH, the UE can be uplink synchronized. During the registration process, the UE can transition to the RRC_Connected Mode. Further, the UE can be sent to RRC_IDLE by the gNB if conditions for RRC_IDLE Mode are satisfied, e.g., the UE has no ongoing data transmissions. The UE can then become available to be paged by the gNB.

Cell search can represent a procedure by which a UE acquires time and frequency synchronization with a cell and detects the cell ID of that cell. Cell selection can represent the decision-making process executed by the UE to choose a specific cell for the UE to register with. Cell reselection can be similar to cell selection except that it can be executed after the UE completes cell selection and enters RRC_IDLE Mode. Once the downlink synchronization is completed by acquiring the synchronization signals, the UE can implement access by performing uplink synchronization. This can be achieved, for example, by means of a RACH procedure. The UE, for instance, transmits a randomly chosen preamble which the gNB can detect and respond with a timing adjustment. This process can enable the UE to align its transmission timing with the gNB, which can enable efficient communication.

Further, when the UE completes synchronization, is registered to the network, and enters RRC_IDLE mode, the UE can be available to be paged by the network. Paging, for example, is a mechanism by which the network informs the UE that it is to be reached, e.g. the UE is to trigger an RRC Connection Setup. For instance, when a UE is paged, the UE can decode the contents of the paging message and based on the paging cause, the UE can execute an appropriate procedure. The UE, for example, is to monitor the physical downlink control channel (PDCCH) periodically to check for the presence of a paging message. This can cause significant power consumption as the UE is to wake up during the configured monitoring occasions to monitor for paging.

In some current wireless communications implementations, a main radio (MR) in the UE is responsible for attaining service from its serving radio network, e.g., gNB. With a low-power radio (also referred to as a low-power wake-up radio (LP-WUR)), the UE can offload some of its main radio functionalities (e.g., paging) to the low-power radio to conserve power. This can be done by allowing the main radio to be operated in sleep mode when the UE is in the coverage of the low-power radio. The low-power radio can use a low-power signal (e.g., low-power wake-up signal (LP-WUS) and/or low-power synchronization signal (LP-SS)) which can enable low power consumption but can result in reduced coverage of the low-power radio as compared to the coverage of the main radio.

Such lower coverage of the low-power radio can result in the low-power radio having a reduced capability in comparison with the main radio. Further, the UE can move in and out of the low-power radio coverage while remaining within the main radio coverage. A radio network may page the UE differently depending on which radio is currently listening at the UE side. Further, if the UE goes out of the low-power radio coverage without informing the gNB and the main radio is asleep, the UE may lose connectivity with the network and may no longer be reachable. If only one radio is in active reception status, the UE may miss some paging messages if the gNB is unaware of the UE's paging status, e.g., active radio in the UE, the active radio's monitoring occasion etc.

Thus, information is to be shared between the gNB and the UE indicating on which radio the UE can be paged. Furthermore, since power consumption may be more pronounced for UE that are mobile (and which could be further increased if the paging context of the UE is outdated), some enhancements are to be considered for when a UE moves from one cell to another.

Accordingly, this disclosure proposes enhancements that can be implemented on the paging mechanism for UE that support the low-power wake-up radio. The enhancements disclosed focus on the configuration of monitoring occasions as well as how this information may be kept updated for UEs that are mobile. In the present disclosure, a corresponding active, listening, and/or receiving radio may be referred to as a “paging radio.”

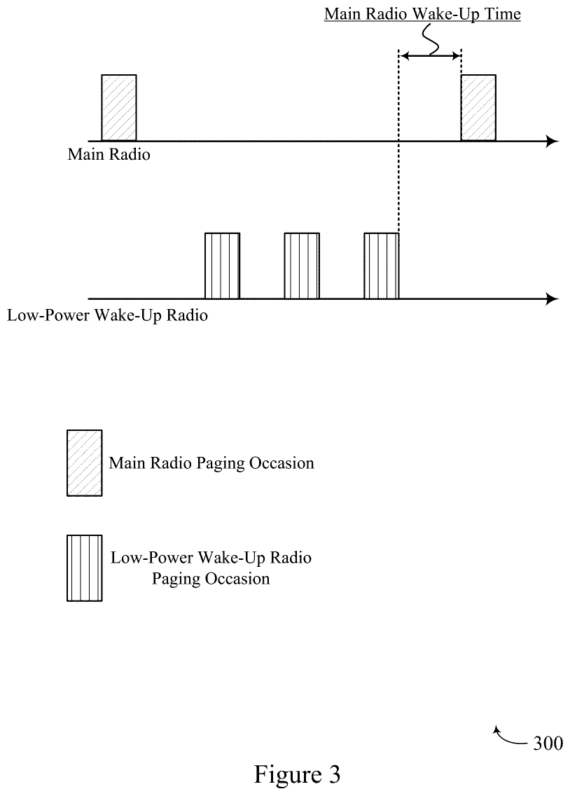

FIG. 3 illustrates at 300 example monitoring occasions for a low-power radio and a main radio in accordance with aspects of the present disclosure. At least some implementations enable different monitoring occasions for a low-power radio and a main radio (MR). For instance, enhancements are described for monitoring occasions of the low-power radio and main radio of the UE. The monitoring occasions of low-power radio and main radio can be configured by gNB to enable power saving gain to be maximized. This can be achieved by allowing the main radio to remain in sleep mode while the low-power radio is in active paging reception status and the UE does not have data to transmit. The gNB can transmit the low-power radio paging a certain offset prior to the main radio paging. Here, the monitoring occasions of the low-power radio and the monitoring occasions of the main radio can be staggered in a way such that the monitoring occasions of low-power radio appear ‘x’ ms before the monitoring occasions of the main radio, where x can be a total time taken for the low-power radio to wake-up (e.g., ramp-up time+time taken for downlink synchronization) the main radio. This configuration can be signaled to the UE by means of System Information Broadcast (e.g., system information block 1 (SIB1)) periodically by the gNB.

In scenarios where a paging is unreceived in the low-power radio monitoring occasions (e.g., either a paging was not transmitted by the gNB or the UE failed to receive the paging), the main radio can be woken up in its monitoring occasions for a possible reception of a paging message. In scenarios where a paging was successfully received in the low-power radio monitoring occasions but the paging was not intended for that particular UE, the main radio can continue to sleep. In scenarios where a paging was received in the low-power radio monitoring occasions which is intended for that particular UE, the main radio can be woken up and allowed to execute the corresponding actions. In one example enhancement, the low-power radio may notify the main radio of a reason for waking up the main radio.

In at least one implementation, as the low-power radio consumes lesser power in comparison to the main radio, the monitoring occasions of the low-power radio are configured to occur more frequently, e.g., the duty cycle of the low-power radio monitoring occasions can be short. During this period, the main radio can remain in sleep mode (e.g., the main radio does not actively transmit or receive), such as provided that the UE remains in RRC_IDLE and has no data to be transmitted. The monitoring occasions of the main radio can be configured to occur less frequently (e.g., the main radio has a longer duty cycle) such as to avoid excessive active time of the main radio and ensure that a paging message that may have been missed by the low-power radio may be received in the main radio monitoring occasions while increased maximum power saving gain. For example, if the monitoring occasions of low-power radio is configured to occur every ‘l’ ms and the monitoring occasions of main radio is configured to occur every ‘m’ ms, then l<m; e.g., the low-power radio monitoring occasions occur more frequently than the main radio monitoring occasions.

In at least one implementation, a paging message transmitted by the network can be configured to be transmitted in the next appropriate monitoring occasion regardless of whether it is an low-power radio or main radio monitoring occasion, and the network can also send the paging in the next main radio monitoring occasion if the previous paging was not received and responded to by the UE. This implementations can seek to ensure that no paging messages is missed even if the low-power radio was unable to receive it correctly.

In at least one implementation, the monitoring occasions of low-power radio and main radio can be separately configured by the gNB using the legacy formula as follows:

SFN for the Paging Frame (PF) is determined by:

(SFN+PF_offset) mod T=(T div N)*(UE_ID mod N)

Index (i_s), indicating the index of the paging occasion is determined by:

i_s=floor (UE_ID/N) mod Ns
where: T represents the DRX cycle of the UE (T is determined by the shortest of the UE specific DRX value(s), if configured by RRC and/or upper layers, and a default DRX value broadcast in system information.

If UE-specific DRX is not configured by RRC or by upper layers, the default value is applied), N can be the number of total paging frames in T, Ns represents the number of monitoring occasions for a PF, PF_offset is the offset used for PF determination, and UE_ID is given by 5G-S-TMSI mod 1024 (e.g., where the parameters are signaled in SIB1).

In at least one implementation the monitoring occasions of low-power radio and main radio may be configured by the gNB in a specific pattern. For example, the monitoring occasions of main radio may be configured as per the legacy IDLE-Mode DRX Duty cycle and ‘y’ low-power radio monitoring occasions may be configured by gNB within one IDLE-Mode DRX duty cycle of the main radio, where y>=1. This configuration can seek to ensure that more monitoring occasions are available for the gNB to page the UE.

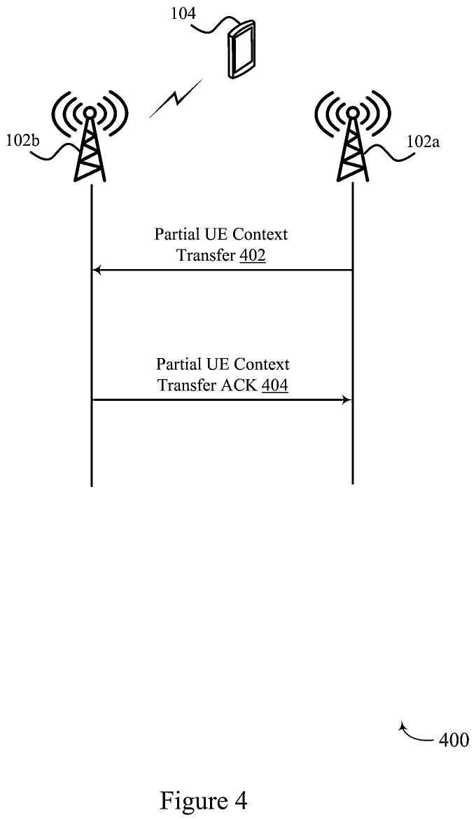

FIG. 4 illustrates a scenario 400 for an example procedure for paging context in a radio network (e.g., for different gNB of a radio network) in accordance with aspects of the present disclosure. For instance, consider a case where a UE is moving to a different cell. The UE paging information thus is to be notified to a new cell and a previous cell is to be made aware of this. For instance, gNB within a tracking area are to be aware of the UE's most recent active paging radio to prevent a discrepancy in paging the UE. Thus, in the scenario 400 a NE 102a (e.g., a previous gNB) transmits a partial UE context transfer 402 to transfer the most recent radio context for a UE 104 to a NE 102b, e.g., a new gNB to which the UE 104 connects. In one more example scenario, the NE 102b then transmits a partial UE context transfer acknowledge (ACK) 404 to the NE 102a acknowledging successful receipt of the partial UE context transfer 402.

In at least some implementations, a gNB of a cell where the UE last transitioned to RRC_IDLE Mode is to remember the most recent low-power radio and/or main radio state of the UE, such as identified using UE paging identity, e.g., S-TMSI. Such paging radio information is then to be shared with surrounding gNBs over the XI interface whenever a paging radio change occurs, e.g., provided that the UE remains in RRC_IDLE Mode. In at least one implementation, this can be achieved by including a new IE (e.g., named Paging Radio) in the XnAP Partial UE Context Transfer such that if the Partial UE Context Transfer IE contains paging context information (e.g., see Table 1, below), the gNb is not to perform a new registration unless required, e.g., provided that the UE need not transition from RRC_IDLE Mode. In implementations the new Paging Radio IE can take either an enumerated value or a Boolean value to represent the paging radio. The new Paging Radio IE can also be an optional field such that if it is not included in the XnAP message the UE can be paged on its main radio by default.

Table 1 below includes information which can be included in the Paging Radio IE including a “Paging Radio” field which can be used to indicate on which radio a UE is to be paged, such as by a new gNB, e.g., the NE 102b in the scenario 400.

TABLE 1
Partial UE Context Transfer

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| New NG-RAN | M | | NG-RAN | Allocated at | YES | reject |
| node UE XnAP | | | node UE | the new | | |
| ID reference | | | XnAP ID | NG-RAN | | |
| | | | 9.2.3.16 | node. | | |
| Old NG-RAN | M | | NG-RAN | Allocated at | YES | ignore |
| node UE XnAP | | | node UE | the old NG- | | |
| ID reference | | | XnAP ID | RAN node. | | |
| | | | 9.2.3.16 | | | |
| Partial UE | M | | 9.2.3.164 | | YES | ignore |
| Context | | | | | | |
| Information for | | | | | | |
| SDT | | | | | | |
| Paging Radio | O | | ENUMER- | Indicates on | | |
| | | | ATED | which radio | | |
| | | | (low-power | the UE | | |
| | | | radio, main | needs to be | | |
| | | | radio) | paged. | | |

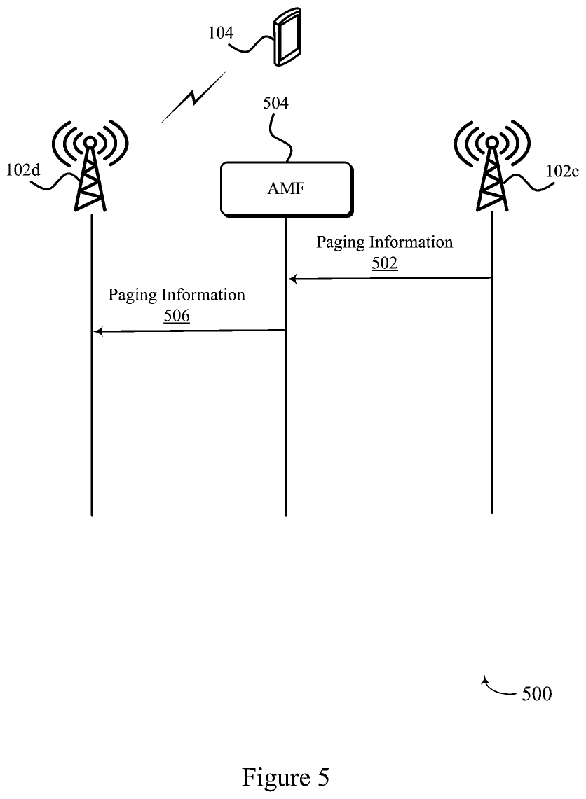

FIG. 5 illustrates a scenario 500 for transmitting paging context in accordance with aspects of the present disclosure. In the scenario 500 a NE 102c transmits paging information 502 for a UE 104 to an AMF 504. Accordingly, when the UE 104 moves from the NE 102c to a NE 102d, the AMF 504 can transmit paging information 506 to the NE 102d to enable the NE 102d to obtain paging radio information regarding the UE 104.

Thus, in implementations a low-power radio and main radio state of a UE can be indicated to the AMF by the gNB (e.g., the gNB of the cell where the UE currently exists) when the gNB receives a paging radio notification. The AMF can maintain this information as part of the paging context of the UE. Once the UE has moved to a new cell, the new gNB (e.g., the gNB of the cell where the UE has moved to) is to be informed of the paging context of the UE. This information, for instance, is shared by the AMF to the new gNB when the UE is to be paged. For instance, when the UE is to be paged, the AMF provides the most recent paging radio information available to the new gNB where the UE is now connected. In this way, gNB within a tracking area can be informed of a UE paging radio.

In implementations, such paging-related information can be included as a new IE. As one example implementation, this new IE called Paging Radio can be an enumerated value that indicates whether the UE is to be paged on the low-power radio or main radio. As another example, the new IE can be a Boolean value that indicates the low-power radio as the paging radio if set to true. Further, it can be an included as an optional field in the PAGING message such that if it is not indicated, the UE gets paged on the main radio by default.

In at least one implementation, such paging information may be included in the PAGING message directly as an IE, e.g., see Table 2 below. In another example implementation, the new Paging Radio IE can be included as a Group Element in the Assistance Data for Paging IE, e.g., see Table 3 below. In yet another example implementation, the Paging Radio IE can be included as a Group Element in the WUS Assistance Information IE, e.g., see Table 4 below.

TABLE 2
PAGING Message

| IE/Group | | | IE type and | Semantics | | Assigned |
|---|---|---|---|---|---|---|
| Name | Presence | Range | reference | description | Criticality | Criticality |
| Message Type | M | | 9.3.1.1 | | YES | ignore |
| UE Paging | M | | 9.3.3.18 | | YES | ignore |
| Identity | | | | | | |
| Paging DRX | O | | 9.3.1.90 | | YES | ignore |
| TAI List for | | 1 | | | YES | ignore |
| Paging | | | | | | |
| >TAI List for | | 1..<maxno | | | — | |
| Paging Item | | ofTAIfor | | | | |
| | | Paging> | | | | |
| >>TAI | M | | 9.3.3.11 | | — | |
| Paging Priority | O | | 9.3.1.78 | | YES | ignore |
| UE Radio | O | | 9.3.1.68 | | YES | ignore |
| Capability for | | | | | | |
| Paging | | | | | | |
| Paging Origin | O | | 9.3.3.22 | | YES | ignore |
| Assistance Data | O | | 9.3.1.69 | | YES | ignore |
| for Paging | | | | | | |
| NB-IoT Paging | O | | 9.3.1.138 | | YES | ignore |
| eDRX | | | | | | |
| Information | | | | | | |
| NB-IoT Paging | O | | 9.3.1.139 | If this IE is | YES | ignore |
| DRX | | | | present, the | | |
| | | | | Paging DRX | | |
| | | | | IE is | | |
| | | | | ignored. | | |
| Enhanced | O | | 9.3.1.140 | | YES | ignore |
| Coverage | | | | | | |
| Restriction | | | | | | |
| WUS | O | | 9.3.1.143 | | YES | ignore |
| Assistance | | | | | | |
| Information | | | | | | |
| E-UTRA | O | | 9.3.1.154 | | YES | ignore |
| Paging eDRX | | | | | | |
| Information | | | | | | |
| CE-mode-B | O | | 9.3.1.155 | | YES | ignore |
| Restricted | | | | | | |
| NR Paging | O | | 9.3.1.227 | | YES | ignore |
| eDRX | | | | | | |
| Information | | | | | | |
| Paging Cause | O | | ENUMERA | | YES | ignore |
| | | | TED | | | |
| | | | (voice, ... ) | | | |
| PEIPS | O | | 9.3.1.232 | | YES | ignore |
| Assistance | | | | | | |
| Information | | | | | | |
| Paging Radio | O | | ENUMER- | Indicates on | | |
| | | | ATED | which radio | | |
| | | | (low-power | the UE | | |
| | | | radio, main | needs to be | | |
| | | | radio) | paged. | | |

| Range bound | Explanation |
|---|---|
| maxnoofTAIforPaging | Maximum no. of TAIs for paging. Value is 16. |

TABLE 3
Assistance Data for Paging IE

| | | | IE type and | Semantics | | Assigned |
|---|---|---|---|---|---|---|
| IE/Group Name | Presence | Range | reference | description | Criticality | Criticality |
| Assistance Data | O | | 9.3.1.70 | | — | |
| for | | | | | | |
| Recommended | | | | | | |
| Cells | | | | | | |
| Paging Attempt | O | | 9.3.1.72 | | — | |
| Information | | | | | | |
| NPN Paging | O | | 9.3.1.183 | | YES | ignore |
| Assistance | | | | | | |
| Information | | | | | | |
| Paging | O | | 9.3.1.141 | | YES | ignore |
| Assistance Data | | | | | | |
| for CE Capable | | | | | | |
| UE | | | | | | |
| Paging Radio | O | | ENUMERATED | Indicates on | | |
| | | | (LR, MR) | which radio | | |
| | | | | the UE needs | | |
| | | | | to be paged. | | |

TABLE 4
WUS Assistance Information IE

| IE/ | | | IE type and | Semantics |
|---|---|---|---|---|
| Group Name | Presence | Range | reference | description |
| Paging | M | | ENUMERATED | Unit: percentage |
| Probability | | | (p00, p05, p10, | |
| Information | | | p15, p20, p25, | |
| | | | p30, p35, p40, | |
| | | | p45, p50, p55, | |
| | | | p60, p65, p70, | |
| | | | p75, p80, p85, | |
| | | | p90, p95, | |
| | | | p100, . . . ) | |
| Paging Radio | O | | ENUMERATED | Indicates on which |
| | | | (low-power | radio the UE needs |
| | | | radio, main | to be paged. |
| | | | radio) | |

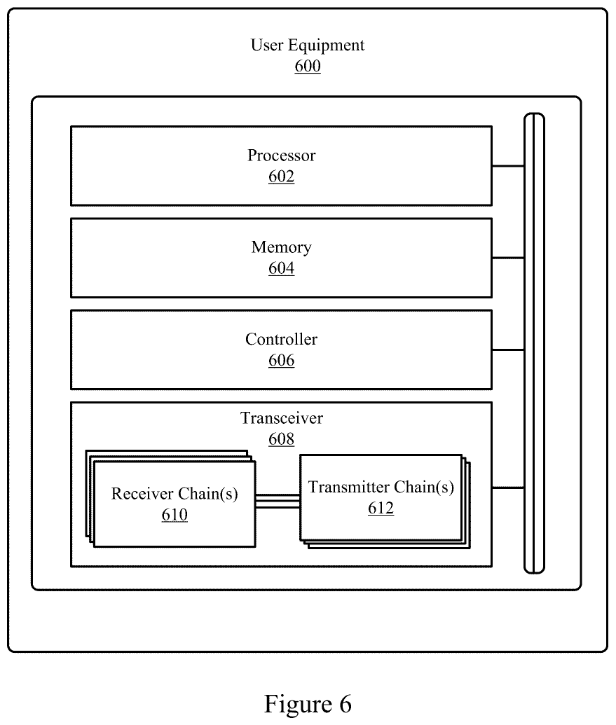

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving a first configuration for calculating one or more low-power radio monitoring occasions and a second configuration for calculating one or more main radio monitoring occasions; and controlling a low-power radio and a main radio based at least in part on the first configuration and the second configuration.

Additionally, the UE 600 may be configured to support any one or combination of controlling the low-power radio and the main radio includes: determining, based at least in part on the first configuration, whether the UE is paged on a low-power radio monitoring occasion; and controlling the main radio based at least in part on whether the UE is paged on the low-power radio monitoring occasion; controlling the low-power radio and the main radio includes: determining that paging is received on the low-power radio monitoring occasion and that the UE is paged; and waking the main radio; notifying the main radio that the UE is paged on the low-power radio monitoring occasion; controlling the low-power radio and the main radio includes: determining that paging is not received on the low-power radio monitoring occasion; and waking the main radio on a main radio monitoring occasion; notifying the main radio that the UE failed to receive paging on the low-power radio monitoring occasion; controlling the low-power radio and the main radio includes: determining that paging is received on the low-power radio monitoring occasion and that the UE is paged; determining that the paging is not directed to the UE; and maintaining the main radio in a sleep mode; controlling the low-power radio and the main radio includes: waking the main radio based at least in part on whether the UE is paged on a low-power radio monitoring occasion; and notifying the main radio of a reason for waking the main radio; receiving one or more of the first configuration or the second configuration via system information broadcast from a base station.

Additionally, or alternatively, the UE 600 may support means to receive a first configuration for calculating one or more low-power radio monitoring occasions and a second configuration for calculating one or more main radio monitoring occasions; and control a low-power radio and a main radio based at least in part on the first configuration and the second configuration.

Additionally, the UE 600 may be configured to support any one or combination of to control the low-power radio and the main radio, the at least one processor is configured to cause the UE to: determine, based at least in part on the first configuration, whether the UE is paged on a low-power radio monitoring occasion; and control the main radio based at least in part on whether the UE is paged on the low-power radio monitoring occasion; to control the low-power radio and the main radio, the at least one processor is configured to cause the UE to: determine that paging is received on the low-power radio monitoring occasion and that the UE is paged; and wake the main radio; the at least one processor is configured to cause the UE to notify the main radio that the UE is paged on the low-power radio monitoring occasion; to control the low-power radio and the main radio, the at least one processor is configured to cause the UE to: determine that paging is not received on the low-power radio monitoring occasion; and wake the main radio on a main radio monitoring occasion; the at least one processor is configured to cause the UE to notify the main radio that the UE failed to receive paging on the low-power radio monitoring occasion; to control the low-power radio and the main radio, the at least one processor is configured to cause the UE to: determine that paging is received on the low-power radio monitoring occasion and that the UE is paged; determine that the paging is not directed to the UE; and maintain the main radio in a sleep mode; to control the low-power radio and the main radio, the at least one processor is configured to cause the UE to: wake the main radio based at least in part on whether the UE is paged on a low-power radio monitoring occasion; and notify the main radio of a reason for waking the main radio; the at least one processor is configured to cause the UE to receive one or more of the first configuration or the second configuration via system information broadcast from a base station.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

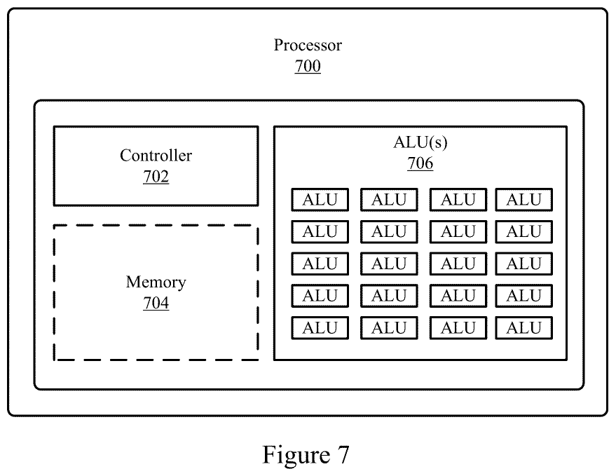

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to receive a first configuration for calculating one or more low-power radio monitoring occasions and a second configuration for calculating one or more main radio monitoring occasions; and control a low-power radio and a main radio based at least in part on the first configuration and the second configuration.

Additionally, the processor 700 may be configured to support any one or combination to determine, based at least in part on the first configuration, whether a UE is paged on a low-power radio monitoring occasion; and control the main radio based at least in part on whether the UE is paged on the low-power radio monitoring occasion; to control the low-power radio and the main radio, the controller is configured to cause the processor to: determine that paging is received on the low-power radio monitoring occasion and that the UE is paged; and wake the main radio; the controller is configured to cause the processor to notify the main radio that the UE is paged on the low-power radio monitoring occasion; to control the low-power radio and the main radio, the controller is configured to cause the processor to: determine that paging is not received on the low-power radio monitoring occasion; and wake the main radio on a main radio monitoring occasion; the controller is configured to cause the processor to notify the main radio that the UE failed to receive paging on the low-power radio monitoring occasion; to control the low-power radio and the main radio, the controller is configured to cause the processor to: determine that paging is received on the low-power radio monitoring occasion and that the UE is paged; determine that the paging is not directed to the UE; and maintain the main radio in a sleep mode; to control the low-power radio and the main radio, the controller is configured to cause the processor to: wake the main radio based at least in part on whether a UE is paged on a low-power radio monitoring occasion; and notify the main radio of a reason for waking the main radio; the controller is configured to cause the processor to receive one or more of the first configuration or the second configuration via system information broadcast from a base station.

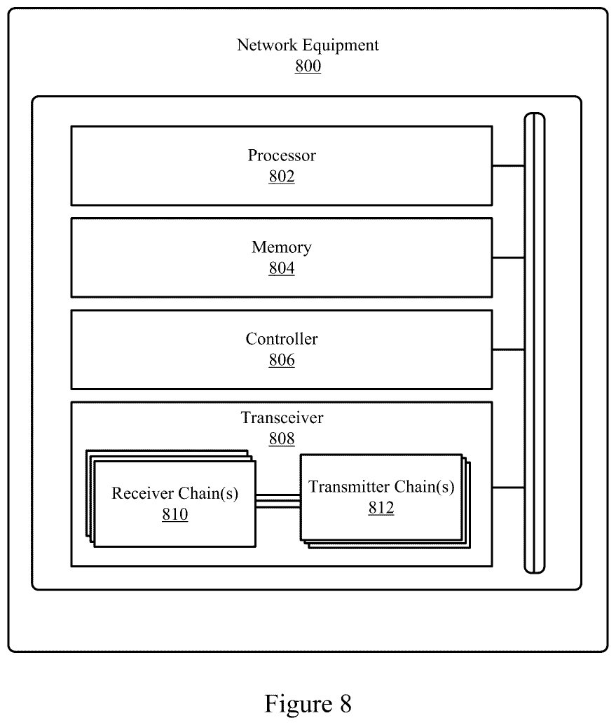

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting, to a UE, a first configuration for calculating one or more low-power radio monitoring occasions and a second configuration for calculating one or more main radio monitoring occasions; transmitting, to the UE, one or more low-power radio paging indications on the one or more low-power radio monitoring occasions; and transmitting, to the UE, one or more main radio paging indications on the one or more main radio monitoring occasions.

Additionally, the NE 800 may be configured to support any one or combination of where the first configuration includes an indication that the one or more low-power radio monitoring occasions are to be at least a time slot threshold earlier than the one or more main radio monitoring occasions; the time slot threshold is configured to enable a low-power radio to wake up a main radio before the main radio is configured to start receiving and transmitting; one or more of the first configuration or the second configuration includes an indication that if the UE is paged on a low-power monitoring occasion, a low-power radio is to wake a main radio; one or more of the first configuration or the second configuration includes an indication that if the UE is not paged on a low-power monitoring occasion, a low-power radio is to wake a main radio; one or more of the first configuration or the second configuration includes an indication that if the UE is paged on a low-power monitoring occasion and paging is not directed to the UE, a low-power radio is not to wake a main radio; determining that the UE moves to a different base station; and transmitting one or more of the first configuration or the second configuration to the different base station; transmitting one or more of the first configuration or the second configuration to a network function; receiving one or more of the first configuration or the second configuration from one or more of a different base station or a network function; transmitting one or more of the first configuration or the second configuration via periodic system information broadcast; the one or more of the first configuration or the second configuration specifies a monitoring occasion pattern for the one or more low-power radio monitoring occasions relative to the one or more main radio monitoring occasions.

Additionally, or alternatively, the NE 800 may support to transmit, to a UE, a first configuration for calculating one or more low-power radio monitoring occasions and a second configuration for calculating one or more main radio monitoring occasions; transmit, to the UE, one or more low-power radio paging indications on the one or more low-power radio monitoring occasions; and transmit, to the UE, one or more main radio paging indications on the one or more main radio monitoring occasions.

Additionally, the NE 800 may be configured to support any one or combination of where the first configuration includes an indication that the one or more low-power radio monitoring occasions are to be at least a time slot threshold earlier than the one or more main radio monitoring occasions; the time slot threshold is configured to enable a low-power radio to wake up a main radio before the main radio is configured to start receiving and transmitting; one or more of the first configuration or the second configuration includes an indication that if the UE is paged on a low-power monitoring occasion, a low-power radio is to wake a main radio; one or more of the first configuration or the second configuration includes an indication that if the UE is not paged on a low-power monitoring occasion, a low-power radio is to wake a main radio; one or more of the first configuration or the second configuration includes an indication that if the UE is paged on a low-power monitoring occasion and paging is not directed to the UE, a low-power radio is not to wake a main radio; the at least one processor is configured to cause the base station to: determine that the UE moves to a different base station; and transmit one or more of the first configuration or the second configuration to the different base station; the at least one processor is configured to cause the base station to transmit one or more of the first configuration or the second configuration to a network function; the at least one processor is configured to cause the base station to receive one or more of the first configuration or the second configuration from one or more of a different base station or a network function; the at least one processor is configured to cause the base station to transmit one or more of the first configuration or the second configuration via periodic system information broadcast; the one or more of the first configuration or the second configuration specifies a monitoring occasion pattern for the one or more low-power radio monitoring occasions relative to the one or more main radio monitoring occasions.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

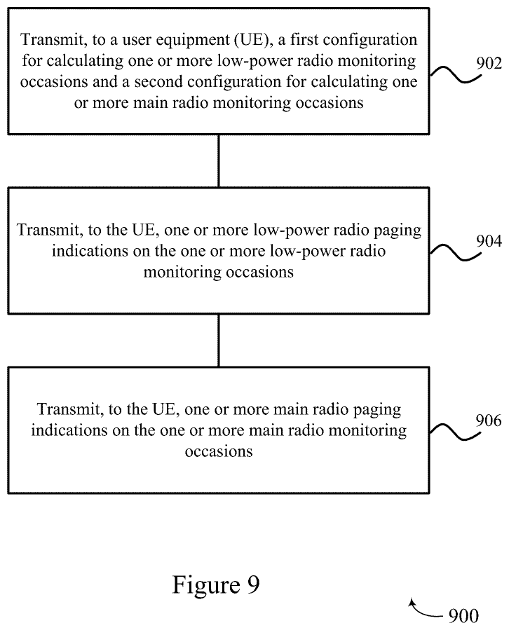

FIG. 9 illustrates a flowchart of a method 900 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting, to a UE, a first configuration for calculating one or more low-power radio monitoring occasions and a second configuration for calculating one or more main radio monitoring occasions. The operations of 902 may be performed in accordance with examples as described herein. In some implementations, aspects of the operations of 902 may be performed by a NE as described with reference to FIG. 8.

At 904, the method may include transmitting, to the UE, one or more low-power radio paging indications on the one or more low-power radio monitoring occasions. The operations of 904 may be performed in accordance with examples as described herein. In some implementations, aspects of the operations of 904 may be performed by a NE as described with reference to FIG. 8.

At 906, the method may include. transmitting, to the UE, one or more main radio paging indications on the one or more main radio monitoring occasions. The operations of 906 may be performed in accordance with examples as described herein. In some implementations, aspects of the operations of 906 may be performed a NE as described with reference to FIG. 8.

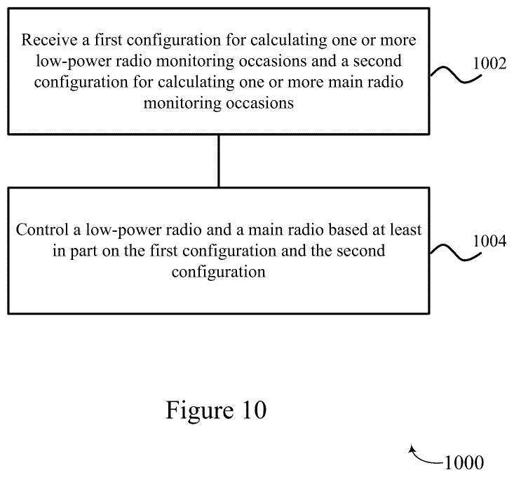

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include receiving a first configuration for calculating one or more low-power radio monitoring occasions and a second configuration for calculating one or more main radio monitoring occasions. The operations of 1002 may be performed in accordance with examples as described herein. In some implementations, aspects of the operations of 1002 may be performed by a NE as described with reference to FIG. 6.

At 1004, the method may include controlling a low-power radio and a main radio based at least in part on the first configuration and the second configuration. The operations of 1004 may be performed in accordance with examples as described herein. In some implementations, aspects of the operations of 1004 may be performed by a NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
transmit, to a user equipment (UE), a first configuration for calculating one or more low-power radio monitoring occasions and a second configuration for calculating one or more main radio monitoring occasions;
transmit, to the UE, one or more low-power radio paging indications on the one or more low-power radio monitoring occasions; and
transmit, to the UE, one or more main radio paging indications on the one or more main radio monitoring occasions.

2. The base station of claim 1, wherein first configuration comprises an indication that the one or more low-power radio monitoring occasions are to be at least a time slot threshold earlier than the one or more main radio monitoring occasions.

3. The base station of claim 2, wherein the time slot threshold is configured to enable a low-power radio to wake up a main radio before the main radio is configured to start receiving and transmitting.

4. The base station of claim 1, wherein one or more of the first configuration or the second configuration comprises an indication that if the UE is paged on a low-power monitoring occasion, a low-power radio is to wake a main radio.

5. The base station of claim 1, wherein one or more of the first configuration or the second configuration comprises an indication that if the UE is not paged on a low-power monitoring occasion, a low-power radio is to wake a main radio.

6. The base station of claim 1, wherein one or more of the first configuration or the second configuration comprises an indication that if the UE is paged on a low-power monitoring occasion and paging is not directed to the UE, a low-power radio is not to wake a main radio.

7. The base station of claim 1, wherein the at least one processor is configured to cause the base station to:
determine that the UE moves to a different base station; and
transmit one or more of the first configuration or the second configuration to the different base station.

8. The base station of claim 1, wherein the at least one processor is configured to cause the base station to transmit one or more of the first configuration or the second configuration to a network function.

9. The base station of claim 1, wherein the at least one processor is configured to cause the base station to receive one or more of the first configuration or the second configuration from one or more of a different base station or a network function.

10. A user equipment (UE) for wireless communication, comprising:
at least one memory; and
at least one processor coupled with the at least one memory and configured to cause the UE to:
receive a first configuration for calculating one or more low-power radio monitoring occasions and a second configuration for calculating one or more main radio monitoring occasions; and
control a low-power radio and a main radio based at least in part on the first configuration and the second configuration.

11. The UE of claim 10, wherein to control the low-power radio and the main radio, the at least one processor is configured to cause the UE to:
determine, based at least in part on the first configuration, whether the UE is paged on a low-power radio monitoring occasion; and
control the main radio based at least in part on whether the UE is paged on the low-power radio monitoring occasion.

12. The UE of claim 11, wherein to control the low-power radio and the main radio, the at least one processor is configured to cause the UE to:
determine that paging is received on the low-power radio monitoring occasion and that the UE is paged; and
wake the main radio.

13. The UE of claim 11, wherein to control the low-power radio and the main radio, the at least one processor is configured to cause the UE to:
determine that paging is not received on the low-power radio monitoring occasion; and
wake the main radio on a main radio monitoring occasion.

14. The UE of claim 11, wherein to control the low-power radio and the main radio, the at least one processor is configured to cause the UE to:
determine that paging is received on the low-power radio monitoring occasion and that the UE is paged;
determine that the paging is not directed to the UE; and
maintain the main radio in a sleep mode.

15. The UE of claim 11, wherein to control the low-power radio and the main radio, the at least one processor is configured to cause the UE to:
wake the main radio based at least in part on whether the UE is paged on a low-power radio monitoring occasion; and
notify the main radio of a reason for waking the main radio.

16. The UE of claim 10, wherein the at least one processor is configured to cause the UE to receive one or more of the first configuration or the second configuration via system information broadcast from a base station.

17. A processor for wireless communication, comprising:
at least one controller coupled with at least one memory and configured to cause the processor to:
receive a first configuration for calculating one or more low-power radio monitoring occasions and a second configuration for calculating one or more main radio monitoring occasions; and
control a low-power radio and a main radio based at least in part on the first configuration and the second configuration.

18. The processor of claim 17, wherein to control the low-power radio and the main radio, the at least one controller is configured to cause the processor to:
determine, based at least in part on the first configuration, whether a user equipment (UE) is paged on a low-power radio monitoring occasion; and
control the main radio based at least in part on whether the UE is paged on the low-power radio monitoring occasion.

19. The processor of claim 18, wherein to control the low-power radio and the main radio, the at least one controller is configured to cause the processor to:
determine that paging is received on the low-power radio monitoring occasion and that the UE is paged; and
wake the main radio.

20. A method performed by a user equipment (UE), the method comprising:
receiving a first configuration for calculating one or more low-power radio monitoring occasions and a second configuration for calculating one or more main radio monitoring occasions; and
controlling a low-power radio and a main radio based at least in part on the first configuration and the second configuration.
